(19) United States
(12) Patent Application Publication
(10) Pub. No.: US 2014/0164128 A1
(43) Pub. Date: Jun. 12, 2014

(54) INFORMATION DELIVERY DEVICE AND INFORMATION DELIVERY METHOD

(71) Applicant: YAHOO JAPAN CORPORATION, Tokyo (JP)

(72) Inventor: Kazuki TAKEDA, Tokyo (JP)

(73) Assignee: YAHOO JAPAN CORPORATION, Tokyo (JP)

(21) Appl. No.: 14/099,349

(22) Filed: Dec. 6, 2013

(30) Foreign Application Priority Data
Dec. 10, 2012 (JP) 2012-269033

(51) Int. Cl. G06Q 30/02

(52) U.S. Cl. CPC G06Q 30/0251; G06Q 30/0261
USPC 705/14.58

(57) ABSTRACT

An information delivery device is provided. Advertisement information, key information, delivery information, and priority information are stored. One piece of advertisement information is transmitted to an advertisement providing device based on priority information. Input information input to a terminal is received. It is determined whether a position of the terminal is within a predetermined region, and whether a correlation between the input information and the key information corresponding to the one piece of advertisement information is within a predetermined permissible range. Based on the result of determination, delivery information corresponding to the one piece of advertisement information is delivered to the terminal. Transmission of relevant information related to the delivery information is detected. The priority information corresponding to the one piece of advertisement information is generated based on at least one of delivery of the delivery information and transmission of the relevant information.

### CROSS-REFERENCE TO RELATED APPLICATIONS

The present application claims priority to and incorporates by reference the entire contents of Japanese Patent Application No. 2012-269033 filed in Japan on Dec. 10, 2012.

### BACKGROUND OF THE INVENTION

1. Field of the Invention

The present invention relates to an information delivery device and an information delivery method, and more particularly, to an information delivery device and an information delivery method for delivering advertisement information to a terminal.

2. Description of the Related Art

Conventionally, advertisement is displayed on digital signage. When advertisement is displayed on a display device such as digital signage, advertisement information can be efficiently conveyed to many users watching the display device, simply by displaying the advertisement information on a display screen.

In addition, it has been proposed to display on the digital signage, a degree of congestion of a passage to a boarding gate or the like and information relevant to the change in the degree of congestion, such as an advertisement (for example, see Japanese Laid-open Patent Publication No. 2012-128395). It has been said that such technique can enhance the advertising effect because the advertisement can be provided together with information in which a user is interested, i.e., information on congestion.

According to the technique disclosed in Japanese Laid-open Patent Publication No. 2012-128395, pieces of relevant information to be provided are determined in advance corresponding to the degrees of congestion; and relevant information to be provided is extracted from the predetermined pieces of information. Further, the change in flight schedule information is regarded as a change in a congestion degree; and a changing situation is not detected based on instantaneous information (real-time information) transmitted from the user side. In addition, no consideration is given to a priority of an advertisement corresponding to the changing situation.

### SUMMARY OF THE INVENTION

It is an object of the present invention to at least partially solve the problems in the conventional technology.

According to one aspect of an embodiment, an information delivery device includes and advertisement information database, an advertisement information transmitting unit, an input information receiving unit, a terminal position determining unit, a correlation determining unit, an information delivering unit, a relevant information transmission detecting unit, and a priority information generating unit. The advertisement information database is configured to store a plurality of pieces of advertisement information, a plurality of pieces of key information, a plurality of pieces of delivery information, and a plurality of pieces of priority information in association with one another. The advertisement information transmitting unit is configured to transmit one piece of advertisement information of the plurality of pieces of advertisement information to an advertisement providing device based on priority information corresponding to the one piece of advertisement information. The input information receiving unit is configured to receive input information input to a terminal. The terminal position determining unit is configured to determine whether a position of the terminal is within a predetermined region. The correlation determining unit is configured to determine whether a correlation between the input information and the key information corresponding to the one piece of advertisement information is within a predetermined permissible range. The information delivering unit is configured to deliver delivery information corresponding to the one piece of advertisement information to the terminal when the terminal position determining unit determines that the position of the terminal is within the predetermined region and the correlation determining unit determines that the correlation is within the predetermined permissible range. The relevant information transmission detecting unit is configured to detect transmission of relevant information related to the delivery information from the terminal that has received the delivery information delivered by the information delivering unit. The priority information generating unit is configured to generate the priority information corresponding to the one piece of advertisement information based on at least one of delivery of the delivery information from the information delivering unit and transmission of the relevant information from the terminal.

According to another aspect of an embodiment, an information delivery method causes a computer to execute, using an advertisement information database configured to store a plurality of pieces of advertisement information, a plurality of pieces of key information, a plurality of pieces of delivery information, and a plurality of pieces of priority information in association with one another: transmitting one advertisement information of the plurality of pieces of advertisement information to an advertisement providing device based on priority information corresponding to the one advertisement information; receiving input information input to a terminal; determining whether a position of the terminal is within a predetermined region, determining whether a correlation between the input information and the key information corresponding to the one advertisement information is within a predetermined permissible range; delivering delivery information corresponding to the one advertisement information to the terminal when it is determined that the position of the terminal is within the predetermined region and it is determined that the correlation is within the predetermined permissible range; detecting transmission of relevant information related to the delivery information from the terminal that has received the delivery information delivered in the delivering; and generating the priority information corresponding to the one advertisement information based on at least one of delivery of the delivery information in the delivering and transmission of the relevant information from the terminal.

According to still another aspect of an embodiment, a computer readable storage medium has stored therein an information delivery program causing a computer to execute a process, using an advertisement information database configured to store a plurality of pieces of advertisement information, a plurality of pieces of key information, a plurality of pieces of delivery information, and a plurality of pieces of priority information in association with one another. The process includes: transmitting one advertisement information of the plurality of pieces of advertisement information to an advertisement providing device based on priority information corresponding to the one advertisement information; receiving input information input to a terminal; determining whether a position of the terminal is within a predetermined region; determining whether a correlation between the input information and the key information corresponding to the one advertisement information is within a predetermined permissible range; delivering delivery information corresponding to the one advertisement information to the terminal when it is determined that the position of the terminal is within the predetermined region and it is determined that the correlation is within the predetermined range; detecting transmission of relevant information related to the delivery information from the terminal that has received the delivery information delivered in the delivering; and generating the priority information corresponding to the one advertisement information based on at least one of delivery of the delivery information in the delivering and transmission of the relevant information from the terminal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram illustrating an overall configuration of an advertising system according to a first embodiment;

FIG. 2 is a block diagram illustrating a schematic internal configuration of an information delivery server;

FIG. 3 is a data structure diagram illustrating a schematic data structure of an advertisement information database;

FIG. 4 is a flowchart for describing an information delivery process performed by an information delivery server;

FIG. 5 is a block diagram illustrating a schematic internal configuration of an information delivery server according to a second embodiment;

FIG. 6 is a data structure diagram illustrating a schematic data structure of a condition information database;

FIG. 7 is a schematic configuration diagram illustrating an overall configuration of an advertising system according to a third embodiment;

FIG. 8 is a schematic configuration diagram illustrating an overall configuration of an advertising system according to a fifth embodiment;

FIG. 9 is a block diagram illustrating a schematic internal configuration of an information delivery server according to the fifth embodiment;

FIG. 10 is a data structure diagram illustrating a schematic data structure of an advertisement information database according to the fifth embodiment; and

FIG. 11 is a flowchart for describing an information delivery process performed by an information delivery server according to the fifth embodiment.

### DETAILED DESCRIPTION OF THE PREFERRED EMBODIMENTS

### First Embodiment

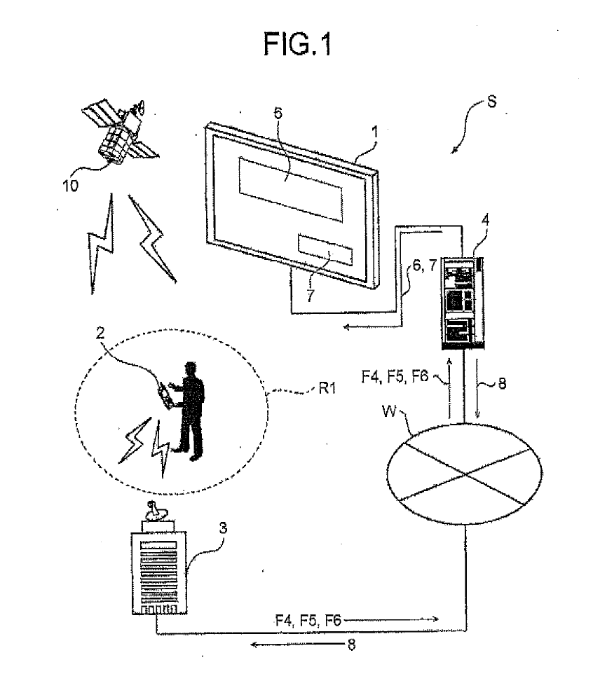

Hereinafter, a first embodiment will be described with reference to the appended drawings. FIG. 1 is a schematic configuration diagram illustrating an overall configuration of an advertising system S according to the first embodiment. The advertising system S is configured such that various kinds of information are transmitted and received among an electronic signage (an advertisement providing device) 1, a terminal 2, an access point (hereinafter, referred to as an “AP”) 3, an information delivery server (information delivery device, for example, computer) 4.

The electronic signage 1 is a device that provides advertisement information, and is called a signage or a digital signage. The electronic signage 1 provides the user (here, the user is a person who is provided with advertisement information, that is, an advertisement viewer) with an advertisement image or video, an advertisement sound, or the like. The electronic signage 1 is installed on the rooftops of buildings, in public facilities, parks, on the sides of roads, or the like to be viewed by many users. For example, a liquid crystal display (LCD) device, a Light Emitting Diode (LED) display device, a plasma display, or the like can be used as the electronic signage 1.

The electronic signage 1 is connected with the information delivery server 4 so that transmission and reception of information can be performed therebetween, and is able to receive advertisement information and key information from the information delivery server 4. The electronic signage 1 is able to provide the advertisement information and the key information received from the information delivery server 4 to the user. Here, the providing of information basically means displaying a still image or a moving image in the electronic signage 1, but when the electronic signage 1 includes a speaker, audio information may be provided to the user as the advertisement information together with the key information.

In FIG. 1, the electronic signage 1 is connected directly with the information delivery server 4, but the electronic signage 1 may be connected to the Internet W, and the electronic signage 1 may be connected with the information delivery server 4 via the Internet W so that transmission and reception of information can be performed therebetween. The advertisement information and the key information will be described later.

The terminal 2 is a terminal that is owned or managed by the user, and for example, a mobile phone, a personal computer, a smartphone, a tablet terminal, or the like can be used. The terminal 2 includes an operation processing device and a memory therein, and includes a screen (display unit) and a keyboard (information input unit). The terminal 2 is connected to the Internet W in a wired or wireless manner, and is able to perform transmission and reception of information with the information delivery server 4.

It is possible to specify the position of the terminal 2. For example, the terminal 2 may include a GPS (Global Positioning System) antenna, and the position of the terminal 2 may be specified based on GPS positioning information obtained by communication with a GPS satellite 10. Further, the position of the terminal 2 may be specified based on a communication path through which transmission and reception of information is performed between the terminal 2 and the information delivery server 4. Specifically, when the terminal 2 is connected to the Internet W, the position of the terminal 2 may be specified by specifying the AP 3 through which information transmitted from the terminal 2 has passed in the communication path. In the present embodiment, the terminal 2 is a mobile phone terminal, and is assumed to include a GPS antenna and be capable of specifying the position thereof based on GPS positioning information. Further, the terminal 2 is assumed to be able to specify the position thereof based on the communication path through which information transmitted from the terminal 2 is received by the information delivery server 4 via the AP 3.

The AP 3 is a relay station that relays information between the terminal 2 and the Internet W, and is able to perform transmission and reception of information with the terminal 2. In the present embodiment, the AP 3 is a base station that performs wireless communication with the terminal 2 that is a mobile phone. The AP 3 may be a WIFi access point that performs wireless communication with the terminal 2. The AP 3 may be a router that performs wired communication or wireless communication with the terminal 2.

The information delivery server 4 is configured to detect a communication path of information which is transmitted from the terminal 2 to the information delivery server 4. In other words, information of an access point through which information input to the terminal 2 has passed until the information is received by the information delivery server 4 is transmitted to the information delivery server 4. The information of the passed access point may be received by the information delivery server 4 as additional information of the information input to the terminal 2.

When input information F4 is input to the terminal 2, passes through the AP 3, and then is received by the information delivery server 4, information representing the fact that the input information F4 has passed through the AP 3 is received by the information delivery server 4 as additional information of the input information F4. Thus, the information delivery server 4 side detects that the terminal 2 is positioned within a range (a predetermined region R1) in which the terminal 2 is able to perform communication with the AP 3. The predetermined region R1 corresponds to a reception range of a radio wave when wireless communication is performed between the terminal 2 and the AP 3. When wired communication is performed between the terminal 2 and the AP 3, the terminal 2 is determined to be in the predetermined region R1 since the terminal 2 is connected with the AP 3 in a wired manner, and the installation position of the AP 3 may be regarded as the position of the terminal 2.

The information delivery server 4 is a server computer connected to the Internet W. The information delivery server 4 is connected with the electronic signage 1 directly or via the Internet W so that transmission and reception of information can be performed therebetween as described above. The information delivery server 4 is connected with the AP 3 via the Internet W and can perform transmission and reception of information with the terminal 2.

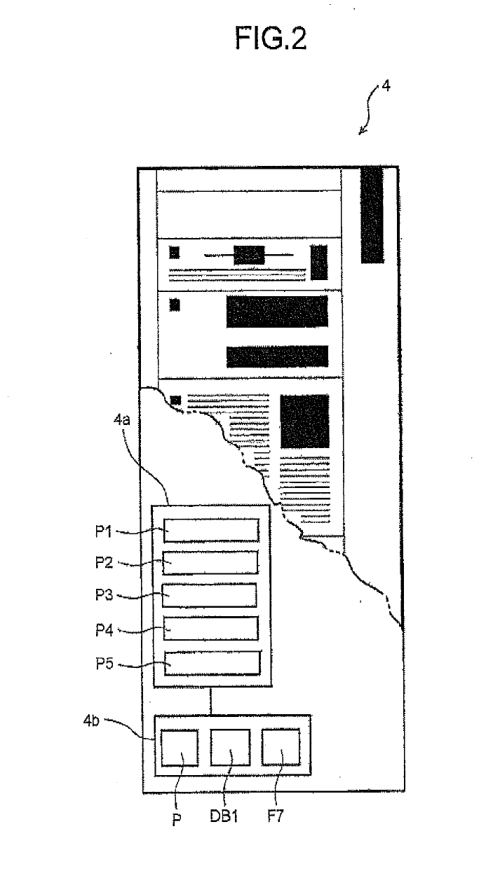

FIG. 2 is a block diagram illustrating a schematic internal configuration of the information delivery server 4. The information delivery server 4 includes a CPU (operation processing device) 4a which is a main part of a computer and a memory (storage device) 4b therein. The memory 4b stores an information delivery program P, an advertisement information database DB11, and region determination information F7. The CPU 4a functions as an advertisement information transmitting unit P1, an input information receiving unit P2, a terminal position determining unit P3, a correlation determining unit P4, and an information delivering unit P5 according to the information delivery program P. Next, respective functions performed by the CPU 4a according to the information delivery program P will be described. The advertisement information database DB1 and the region determination information F7 will be described later.

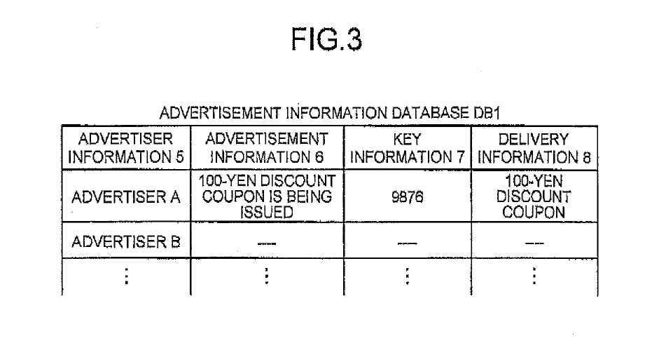

The advertisement information transmitting unit P1 has a function of transmitting advertisement information 6 and key information 7 (see FIG. 3) to the electronic signage 1.

The advertisement information 6 is information which an advertiser such as a company desires to provide (display or output audibly) through the electronic signage 1 and is basically used to advertise content or a price of a product or a service of an advertiser. The advertisement information 6 includes any one of video (moving image) information, image (still image) information, and audio information or a combination thereof. The advertisement information 6 is transmitted from the information delivery server 4 to the electronic signage 1, and provided to the user through the electronic signage 1. The advertisement information 6 is stored in the advertisement information database DB1 as data.

The key information 7 is information provided to the user through the electronic signage 1 together with the advertisement information 6. Of course, the key information 7 may be transmitted to the electronic signage 1 at the same timing as or a different timing from the advertisement information 6. For example, the key information 7 is configured with a multi-digit (or - character) passcode, a keyword, a query of a quiz type, and the like, and the user can input the input information F4 to the terminal 2 based on the key information 7. The key information 7 includes any one of video (moving image) information, image (still image) information, and audio information or a combination thereof. For example, the key information 7 may be numerical information or text information. In the first embodiment, the key information 7 is assumed to be a 4-digit (or -character) passcode.

FIG. 3 is a data structure diagram illustrating a schematic data structure of the advertisement information database DB1. The advertisement information database DB1 is constructed such that advertiser information 5, the advertisement information 6, and the key information 7 are associated with one another. For example, in the advertisement information database DB1, an advertiser A, advertisement information such as “100-yen discount coupon is being issued!,” and key information such as “9876” are associated with one another as illustrated in FIG. 3. The advertisement information transmitting unit P1 transmits the advertisement information 6 and the key information 7 to the electronic signage 1 with reference to the advertisement information database DB1.

In the advertisement information database DB1, delivery information 8 is associated with the advertisement information 6 as well. The delivery information 8 is information to be transmitted from the information delivery server 4 to the terminal 2, and the details thereof will be described later.

The input information receiving unit P2 has a function of receiving the input information F4 input to the terminal 2 by the user together with communication path information F5 and terminal position information T6. When the user inputs the input information F4 to the terminal 2, the input information F4 passes through the AP 3. Then, the input information receiving unit P2 receives the input information F4 via the Internet W together with the information (communication path information) F5 representing that the input information F4 has passed through the AP 3.

For example, an application (input application) for inputting input information may be stored in the terminal 2, and the input information F4 may be input to the terminal 2 through an input frame of the application after the input application is activated. Further, the input information F4 may be input to the terminal 2 through a search word input frame of a search site displayed by the Internet browser.

The terminal 2 according to the first embodiment includes the GPS antenna and can perform GPS positioning, and thus when the input information F4 is input to the terminal 2, the current position of the terminal 2 is measured by the GPS satellite 10. The input information receiving unit P2 receives the GPS positioning information as the terminal position information F6 together with the input information F4. Further, when the terminal 2 has no GPS positioning function, the communication path information F5 may be used as the terminal position information F6.

The terminal position determining unit P3 has a function of determining whether the position of the terminal 2 is within the predetermined region R1 based on the terminal position information F6 received from the terminal 2 by the input information receiving unit P2. The information delivery server 4 holds the region determination information F7 corresponding to the predetermined region R1 in the memory 4b. The region determination information F7 is information used as a determination criterion as to whether the position of the terminal 2 is within the predetermined region R1. The terminal position determining unit P3 compares the region determination information F7 with the terminal position information F6, and determines whether the position of the terminal 2 is within the predetermined region R1.

For example, the region determination information F7 may be latitude/longitude (L/L) information corresponding to the predetermined region R1. It is determined whether the position of the terminal 2 is within the predetermined region R1 by comparing the GPS positioning information serving as the terminal position information F6 with the region determination information F7. Further, when the communication path information F5 is used as the terminal position information F6, the region determination information F7 may be access point information. For example, when the region determination information F7 is information representing the AP 3 and the communication path information F5 used as the terminal position information F6 is also information representing the AP 3, it may be determined that the position of the terminal 2 is within the predetermined region R1.

In the first embodiment, the terminal position determining unit P3 is configured to determine the position of the terminal 2 based on both the GPS positioning information serving as the terminal position information F6 and the communication path information F5. Then, when the determination based on the GPS positioning information contradicts the determination based on the communication path information F5, the determination based on the communication path information F5 is given priority (employed). Here, the “contradiction” means a case in which both the GPS positioning information and the communication path information F5 are received by the input information receiving unit P2, the determination based on one information represents that the position of the terminal 2 is within the predetermined region R1, but the determination based on the other information represents that the position of the terminal 2 is outside the predetermined region R1. A case in which one of the GPS positioning information and the communication path information F5 is not received by the input information receiving unit P2 (there is no information) is excluded.

Specifically, when there is the GPS positioning information but there is not the communication path information F5, the position of the terminal 2 is determined based on the GPS positioning information. When there is not GPS positioning information and there is the communication path information F5, the position of the terminal 2 is determined based on the communication path information F5. When there are both the GPS positioning information and the communication path information F5 but the determinations based on two pieces of information contradict, the position of the terminal 2 is determined based on the communication path information F5 rather than the GPS positioning information.

Of course, when the determination based on the GPS positioning information contradicts the determination based on the communication path information F5, the determination based on the GPS positioning information may be given priority. The determination based on information that is given priority is decided, at a design stage, based on the accuracy of the GPS positioning information or the like.

The correlation determining unit P4 has a function of determining whether a correlation between the input information F4 and the key information 7 is within a predetermined permissible range. The input information F4 is received and acquired by the input information receiving unit P2, and the key information 7 is acquired with reference to the advertisement information database DB1. “The correlation between the input information F4 and the key information 7 may be within the predetermined permissible range” includes the case where the input information F4 matches the key information 7. For example, in the first embodiment, since the key information 7 includes the passcode of “9876,” if the input information F4 is “9876,” the correlation between the input information F4 and the key information 7 is determined to be within the predetermined permissible range.

For example, when the key information 7 is a “query of a quiz type” and the input information F4 is a “correct answer” to the query, the correlation between the input information F4 and the key information 7 is determined to be within the predetermined permissible range. In this case, the memory 4b may stores correct answer information (not illustrated) corresponding to the key information 7, and the correlation determining unit P4 may compare the correct answer information with the input information F4 and determine the correlation between the input information F4 and the key information 7.

The information delivering unit P5 has a function of delivering the delivery information 8 to the terminal 2. The delivery information 8 is information associated with the advertisement information 6, and is stored in the advertisement information database DB1. Preferably, the delivery information 8 is information which will bring benefit to the recipient. For example, the delivery information 8 may be coupon information such as “100-yen discount coupon.” The delivery information 8 is delivered from the information delivery server 4 to the terminal 2 via the Internet W.

The information delivering unit P5 delivers the delivery information 8 to the terminal 2 based on the determination made by the terminal position determining unit P3 and the determination made by the correlation determining unit P4. In other words, only when the terminal position determining unit P3 determines that the position of the terminal 2 is within the predetermined region R1 and the correlation determining unit P4 determines that the correlation between the input information F4 and the key information 7 is within the predetermined permissible range, the information delivering unit P5 delivers the delivery information 8 to the terminal 2.

Thus, it is possible to implement a technique in which “coupon information is delivered to the terminal 2 of the user only when the user who has viewed the passcode displayed on the electronic signage 1 inputs the same passcode to the terminal 2 around the electronic signage 1.” When the region determination information F7 is set to indicate a region corresponding to the position around the installation position of the electronic signage 1, the user who stays within the predetermined region R1 can view the electronic signage 1. When the AP 3 is installed around the installation position of the electronic signage 1, information transmitted from the terminal 2 of the user who has viewed the electronic signage 1 passes through the AP 3.

In other words, when the terminal position determining unit P3 determines that the terminal 2 is within the predetermined region R1, the user of the terminal 2 can be inferred to be at the position at which the user can view the electronic signage 1 with a high degree of accuracy. When the correlation determining unit P4 determines that the correlation between the input information F4 and the key information 7 is within the predetermined permissible range, the user can be inferred to have paid attention to the advertisement information 6 of the advertiser A provided on the electronic signage 1 and viewed the key information 7 associated with the advertisement information 6 with a high degree of accuracy.

Thus, it is possible to deliver the delivery information 8 to only the user who stays around the electronic signage 1 and has actually viewed the key information 7 on the electronic signage 1. It is possible to prevent the delivery information 8 from being delivered to the user who does not stay around the electronic signage 1. Further, it is possible to prevent the delivery information 8 from being delivered to the user who stays around the electronic signage 1 but has not viewed the key information 7 without paying attention to the advertisement information 6 of the advertiser A. Thus, an effect of preventing abuse of the delivery information 8 and an effect of preventing the delivery information 8 from being uselessly delivered to the user from whom an advertising effect is not expected can be obtained.

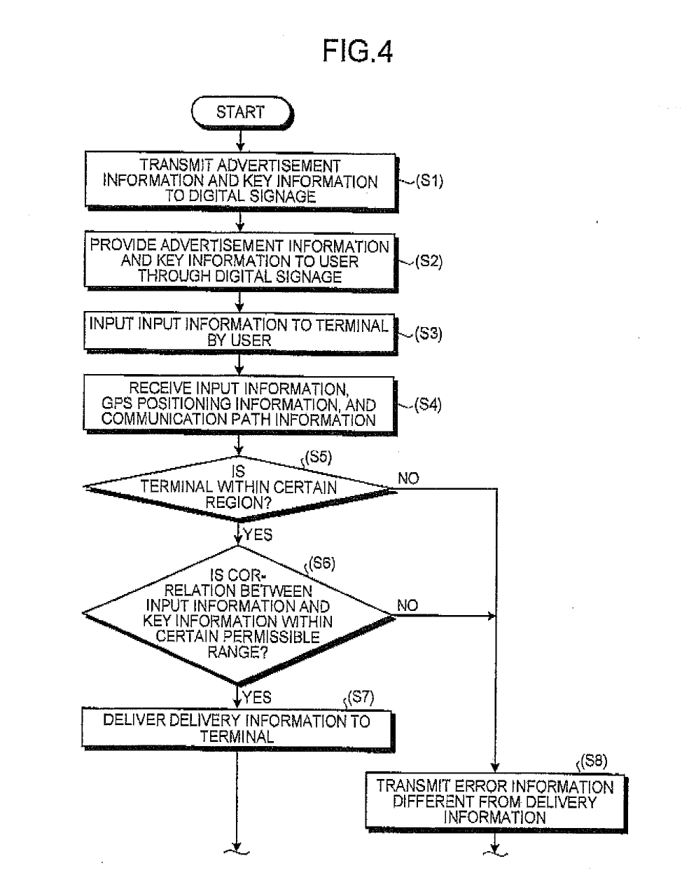

Next, an information delivery process performed by the information delivery server 4 will be described with reference to a flowchart of FIG. 4.

The advertisement information transmitting unit P1 transmits the advertisement information 6 of the advertiser A and the key information 7 to the electronic signage 1 based on the advertisement information database DB1 (S1). The electronic signage 1 provides the advertisement information 6 and the key information 7 toward the user (S2). The user who has viewed the electronic signage 1 activates the input application in the terminal 2, accesses the search site, and inputs the input information F4 to the input frame (S3). The input information F4 arrives at the information delivery server 4 via the AP 3 and the Internet W, and is received by the input information receiving unit P2 (S4). At this time, the input information receiving unit P2 receives the GPS positioning information of the terminal 2 and the communication path information F5 as well as the input information F4 (S4).

The terminal position determining unit P3 determines whether the terminal 2 is within the predetermined region R1 based on the GPS positioning information (S5). The terminal position determining unit P3 determines whether the terminal 2 is within the predetermined region R1 based on the communication path information F5 (S5). Here, when the determination based on the GPS information contradicts the determination based on the communication path information F5, the determination based on the communication path information F5 is given priority.

When the terminal 2 is determined to be within the predetermined region R1, the correlation determining unit P4 determines whether the correlation between the input information F4 and the key information 7 is within the predetermined permissible range (S6). Specifically, it is determined whether the passcode input as the input information F4 matches the passcode of the key information 7 by comparing the input passcode with the passcode of the key information 7. Then, when the correlation between the input information F4 and the key information 7 is determined to be within the predetermined permissible range (both pieces of information match), the information delivering unit P5 delivers the coupon information to the terminal 2 as the delivery information 8 (S7). For example, when the terminal 2 of the user stores the coupon information serving as the delivery information 8 and the user does shopping at a store of the advertiser A, the user can obtain a benefit (for example, 100-yen discount) based on the content of the coupon.

In the above description, the order of steps S5 and S6 is not consequential. It is a design factor whether the terminal position determining unit P3 first makes the determination or the correlation determining unit P4 first makes the determination. When the terminal position determining unit P3 determines that the position of the terminal 2 is outside the predetermined region R1 in step S5, the information delivering unit P5 transmits error information different from the delivery information 8 such as an error message “you are outside an area” to the terminal 2 (S8). Further, when the correlation determining unit P4 determines that the correlation between the input information F4 and the key information 7 is outside the predetermined permissible range in step S6, the information delivering unit P5 transmits error information different from the delivery information 8 such as an error message “it is an error” to the terminal 2 (S8).

### Second Embodiment

An information delivery server 4 according to a second embodiment will be described. In the second embodiment, the same components as in the first embodiment are denoted by the same reference numerals, and a description thereof will not be provided.

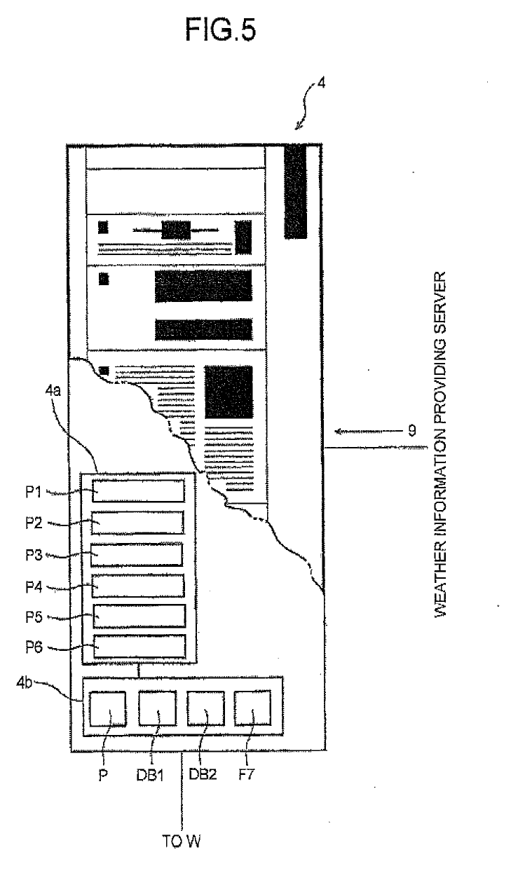

The information delivery server 4 according to the second embodiment has approximately the same components as the information delivery server 4 according to the first embodiment. A memory 4b of the information delivery server 4 according to the second embodiment stores an advertisement information database DB1 and a condition information database DB2 as illustrated in FIG. 5. Further, an information delivery program P according to the second embodiment stored in the memory 4b causes a CPU 4a to function as a condition information receiving unit P6 in addition to the units P1 to P5 described in the first embodiment.

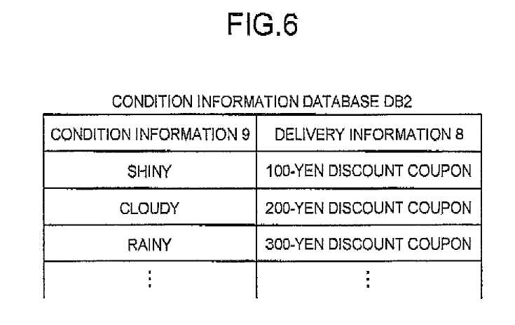

FIG. 6 is a data structure diagram illustrating a schematic data structure of the condition information database DB2. The condition information database DB2 is constructed such that the delivery information 8 is associated with condition information 9. The condition information 9 is information used as a determination criterion for selecting delivery information to be delivered by the information delivering unit P5. For example, in the second embodiment, delivery information to be delivered is changed according to whether the weather of the day is “shiny,” “cloudy,” or “rainy.”

The condition information database DB2 stores three kinds of information such as “shiny,” “cloudy,” and “rainy” as the condition information 9. Further, the different pieces of delivery information 8 are associated with the respective pieces of condition information 9. For example, the condition information 9 of “shiny” is associated with the delivery information 8 of “100-yen discount coupon,” the condition information 9 of “cloudy” is associated with the delivery information B of “200-yen discount coupon,” and the condition information 9 of “rainy” is associated with the delivery information 8 of “300-yen discount coupon.”

A weather information providing server (not illustrated) serving as a condition information providing device is connected to the information delivery server 4 directly or via the Internet W. The condition information 9 of any one of “shiny,” “cloudy,” and “rainy” is input from the weather information providing server as today's weather information.

The condition information receiving unit P6 has a function of receiving an input of the condition information 9 from the weather information providing server (server computer). Further, the condition information receiving unit P6 has a function of changing the delivery information 8 to be delivered according to the content of the received condition information 9. When the condition information 9 received by the condition information receiving unit P6 is “shiny,” “100-yen discount coupon” is selected based on the condition information database DB2 as the delivery information 8, and the information delivering unit P5 delivers information of “100-yen discount coupon” to the terminal 2. When the condition information 9 received by the condition information receiving unit P6 is “cloudy,” “200-yen discount coupon” is selected based on the condition information database DB2 as the delivery information 8, and the information delivering unit P5 delivers information of “200-yen discount coupon” to the terminal 2. When the condition information 9 received by the condition information receiving unit P6 is “rainy,” “300-yen discount coupon” is selected based on the condition information database DB2 as the delivery information 8, and the information delivering unit P5 delivers information of “300-yen discount coupon” to the terminal 2.

As described above, it is possible to deliver delivery information of a different content to the terminal 2 according to the content of the input condition information, and thus it is possible to provide a variety of benefits to the user and improve the advertising effect. On rainy days when customers are reduced, delivery of a coupon having a high discount rate may make it possible to increase the number of customers visiting the store.

Further, the same delivery information 8 may be associated with the respective pieces of condition information 9 in the condition information database DB2. For example, all of the condition information 9 of “shiny,” the condition information 9 of “cloudy,” and the condition information 9 of “rainy” may be associated with the same delivery information 8 of “300-yen discount coupon.” In this case, the delivery information of the same content is delivered to the terminal 2 according to the content of the input condition information.

### Third Embodiment

An advertising system S according to a third embodiment will be described. In the third embodiment, the same components as in the first embodiment are denoted by the same reference numerals, and thus a description thereof will not be repeated.

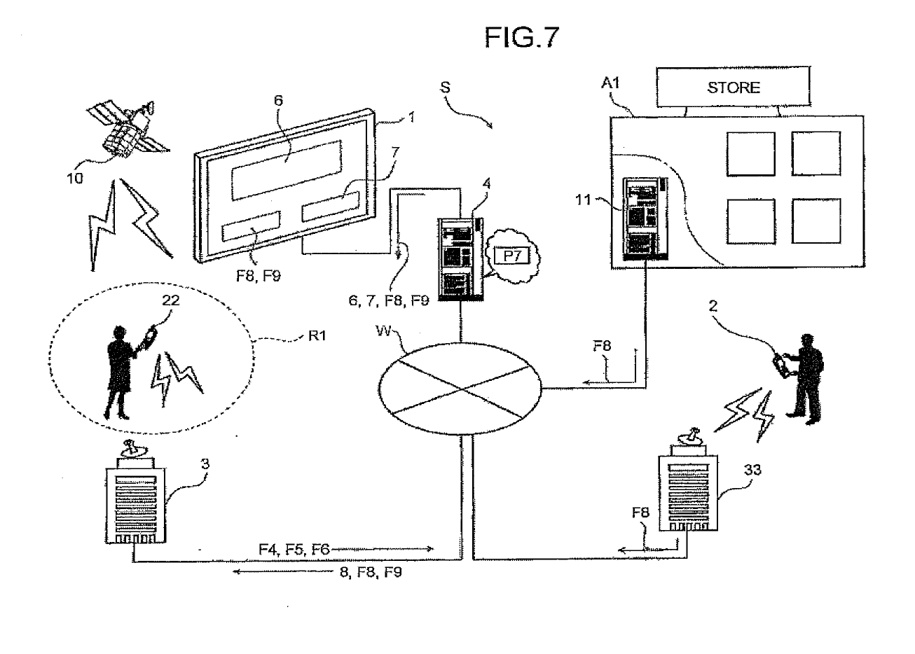

FIG. 7 is a schematic configuration diagram illustrating an overall configuration of the advertising system S according to the third embodiment. In the third embodiment, a store server (server computer) 11 in a store A1 of the advertiser A configures the advertising system S as well. The store server 11 can perform transmission and reception of information with the information delivery server 4 via the Internet W. An information delivery program P stored in the memory 4b of the information delivery server 4 causes the CPU 4a to function as a relevant information acquiring unit P7 in addition to the units P1 to P5 described in the first embodiment.

Within the predetermined region R1, the user who has received the coupon information serving as the delivery information 8 comes to the store A1, and does shopping using a 100-yen discount coupon serving as the delivery information 8. Information (relevant information) F8 representing that the coupon serving as the delivery information 8 has been used is transmitted from the store server 11 to the information delivery server 4 via the Internet W. Here, the relevant information F8 is information relevant to information transmitted from the terminal 2 in connection with the delivery information 8. In other words, the coupon information is transmitted from the terminal 2 to the store server 11, and the relevant information (information representing that the coupon has been used) F8 is transmitted to the information delivery server 4 in connection with the coupon information.

The information delivery server 4 acquires the relevant information F8 through the relevant information acquiring unit P7. When the relevant information F8 is acquired, the advertisement information transmitting unit P1 may transmit usage information F9 to the electronic signage 1 based on the relevant information F8 together with the advertisement information 6 of the advertiser A. For example, the usage information F9 is information used to cause a message “100-yen discount coupon was now used!” to be displayed on the electronic signage 1. Further, an upper limit of the number of available pieces of coupon information serving as the delivery information 8 may be set in advance, the remaining number of available coupons may be deducted each time the relevant information F8 is acquired, and then the number of remaining available coupons may be displayed on the electronic signage 1 as the usage information F9.

When the relevant information F8 is acquired and then the delivery information 8 is delivered to a terminal 22 of another user staying within the predetermined region R1, the relevant information F8 or the usage information F9 may be delivered to the terminal 22 together with the delivery information 8. Thus, it is possible to deliver the coupon information serving as the delivery information 8 to the terminal 22 and display information representing that the coupon has been used, such as a message “100-yen discount coupon was now used!,” and the number of remaining available coupons.

Further, when the user of the terminal 2 uses the coupon serving as the delivery information 8 and then makes a posting about the product or the store A related to the advertisement information 6 on Facebook (a registered trademark) or Twitter (a registered trademark), the relevant information acquiring unit P7 of the information delivery server 4 acquires the content of the posting as the relevant information F8. The content is transmitted to the information delivery server 4 via an access point 33 connected to the Internet W.

The posted content serving as the relevant information F8 or message information such as “there is a posting related to a coupon!” serving as the usage information F9 based on the relevant information F8 may be transmitted from the information delivery server 4 to the electronic signage 1 or may be delivered to the terminal 22 together with the delivery information 8.

### Fourth Embodiment

The first embodiment has been described in connection with the example in which the advertisement information transmitting unit P1 transmits the key information 7 to the electronic signage 1 together with the advertisement information 6. A fourth embodiment will be described in connection with an example in which the key information 7 is not transmitted to the electronic signage 1.

The advertisement information transmitting unit P1 transmits the advertisement information 6 to the electronic signage 1, but does not transmit the key information 7 to the electronic signage 1. In this case, the key information 7 is not provided to the user through the electronic signage 1. The key information 7 is associated with the advertisement information 6 in the advertisement information database D81. For example, a keyword (a company name of the advertiser A) may be used as the key information 7.

When the user who has viewed the advertisement information 6 displayed on the electronic signage 1 accesses a search site through the terminal 2 and inputs the input information F4 (the company name of the advertiser A) to the input frame of the search site, the information delivery server 4 receives the input information F4 together with the terminal position information F6 and the communication path information F5 via the Internet W. When the terminal 2 is determined to be within the predetermined region R1 and the correlation between the input information F4 and the key information 7 in the advertisement information database DB1 is determined to be within a predetermined permissible range (for example, both pieces of information match), the information delivery server 4 delivers the delivery information 8 to the terminal 2. The delivery information 8 may be displayed on the display screen of the terminal 2 in the form of a search list.

In the fourth embodiment, similarly to the second embodiment, the information delivery server 4 may change the delivery information 8 to be delivered to the terminal 2 according to the condition information 9 from the condition information providing device. Further, similarly to the third embodiment, the relevant information F8 transmitted from the store server 11 or another terminal 2 in connection with the delivery information 8 or the usage information F9 based on the relevant information F8 may be transmitted from the information delivery server 4 to the electronic signage 1 or the terminal 22.

### Fifth Embodiment

An advertising system S according to a fifth embodiment will be described. In the fifth embodiment, the same components as in the third embodiment are denoted by the same reference numerals, and a description thereof will not be repeated.

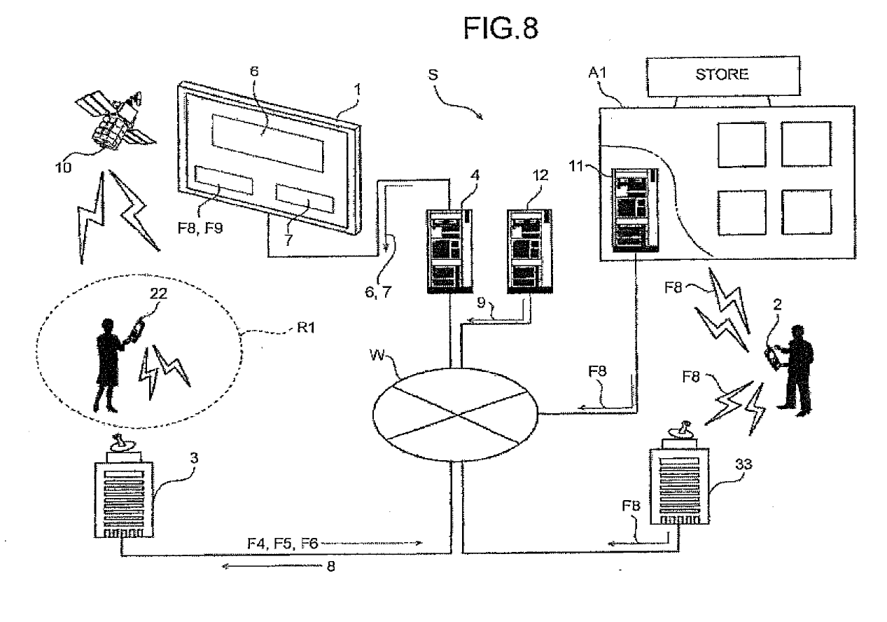

FIG. 8 is a schematic configuration diagram illustrating an overall configuration of the advertising system S according to the fifth embodiment. In the fifth embodiment, the information delivery server 4 generates priority information of advertisement information based on the relevant information F8 received from the store server 11 or the AP 33 and ranks a plurality of pieces of advertisement information. Further, similarly to the second embodiment, the delivery information B is changed based on the weather information (condition information) 9 received from the weather information providing server 12.

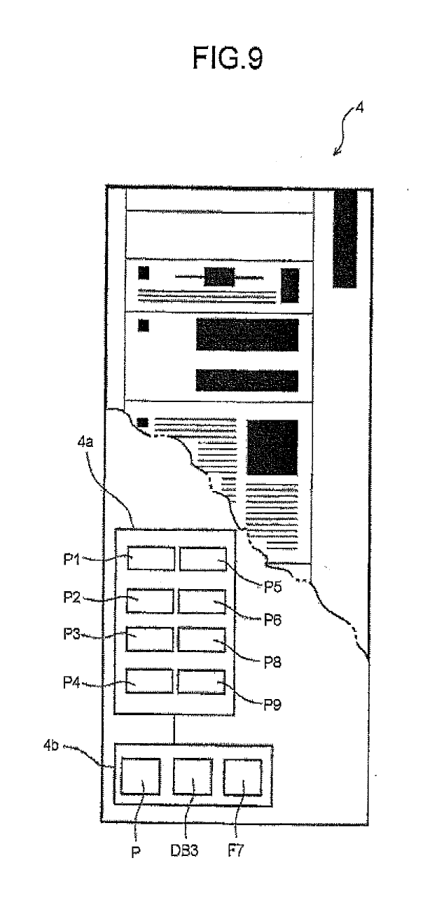

FIG. 9 is a block diagram illustrating a schematic internal configuration of the information delivery server 4 according to the fifth embodiment. A memory 4b in the information delivery server 4 stores an information delivery program P and an advertisement information database DB3. The information delivery program P causes a CPU 4a serving as a main part of a computer to function as an advertisement information transmitting unit P1, an input information receiving unit P2, a terminal position determining unit P3, a correlation determining unit P4, an information delivering unit P5, a condition information receiving unit P6, a relevant information transmission detecting unit P8, and a priority information generating unit P5. The respective functions implemented by the CPU 4a according to the information delivery program P will be described later.

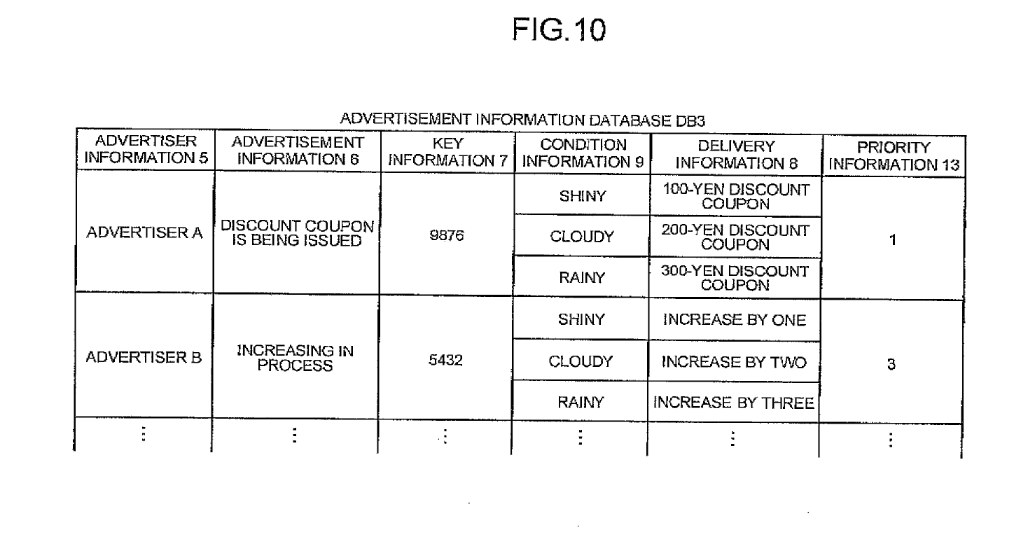

FIG. 10 is a data structure diagram illustrating a schematic data structure of the advertisement information database DB3 according to the fifth embodiment. The advertisement information database DB3 is constructed such that a plurality of pieces of the advertiser information 5, the advertisement information 6, the key information 7, the weather information 9, the delivery information 8, and the priority information 13 are associated with one another. The advertiser information 5, the advertisement information 6, the key information 7, the weather information 9, and the delivery information 8 are the same as those described in the first to third embodiments, and thus a description thereof will not be repeated.

The advertisement information database D83 according to the fifth embodiment has both the configuration of the advertisement information database DB1 described in the first embodiment and the configuration of the condition information database DB2 described in the second embodiment. In other words, for the advertisement information 6, each of a plurality of pieces of delivery information 8 is associated with each piece of weather information 9. The delivery information 8 is associated with the weather information 9 such that “100-yen discount coupon” is delivered as the delivery information 8 when the weather information 9 is “shiny,” “200-yen discount coupon” is delivered as the delivery information 8 when the weather information 9 is “cloudy,” and “300-yen discount coupon” is delivered as the delivery information 8 when the weather information 9 is “rainy.”

The priority information 13 is information that is generated by the priority information generating unit P9 and is used for ranking the advertisement information 6. For example, the priority information 13 represents a rank, and when there are five pieces of advertisement information 6, the priority information 13 of “1” may be the highest in priority, a rank may decrease each time the number increases, and the priority information 13 of “5” may be the lowest in priority. Further, the priority information 13 is a numerical value calculated based on a priority information calculation process which will be described later, and as a numerical value increases, priority may increase.

The advertisement information 6 associated with the priority information 13 having a high priority is transmitted to the electronic signage 1 prior to the advertisement information 6 associated with the priority information 13 having a low priority. Here, “the advertisement information 6 is transmitted with a high priority to the electronic signage 1” means that the advertisement information 6 is provided in preference to other pieces of advertisement information; for example, the advertisement information 6 is displayed on the electronic signage 1 “for a longer period of time,” “more frequently,” “with a louder volume,” or “in a more noticeable manner” than other advertisement information.

The CPU 4a functions as the advertisement information transmitting unit P1, the input information receiving unit P2, the terminal position determining unit P3, the correlation determining unit P4, the information delivering unit P5, the condition information receiving unit P6, the relevant information transmission detecting unit P8, and the priority information generating unit P9. Here, the functions of the advertisement information transmitting unit P1, the input information receiving unit P2, the terminal position determining unit P3, the correlation determining unit P4, and the information delivering unit P5 are the same as those described in the first embodiment, and thus a description thereof will not be repeated.

The condition information receiving unit P6 is similar to that described in the second embodiment in receiving the weather information 9 transmitted from a weather information providing server 12 serving as a condition information providing device as the condition information and changing the delivery information 8 to be delivered according to the content of the condition information. In the second embodiment, the delivery information 8 is changed with reference to the condition information database DB2, but in the fifth embodiment, the delivery information 8 is changed with reference to the advertisement information database DB3. The remaining points are similar to those in the second embodiment, and a description thereof will not be provided.

The relevant information transmission detecting unit P8 has a function of detecting the fact that the relevant information F8 has been transmitted from the terminal 2. Specifically, the relevant information transmission detecting unit P8 detects the fact that the relevant information F8 related to the use of the coupon has been transmitted from the terminal 2 to the store server 11 when the coupon serving as the delivery information 8 is used at the store A1. The relevant information F8 related to the use of the coupon or other information (hereinafter, referred to as the “relevant information F8 or the like”) related thereto is transmitted from the store server 11 to the information delivery server 4 via the Internet W. The relevant information transmission detecting unit P8 receives the relevant information F8 or the like, and detects the fact that the relevant information F8 has been transmitted from the terminal 2.

Further, after the user of the terminal 2 uses the coupon serving as the delivery information 8 and then posts a product related to the advertisement information 6 or the store A1, for example, on Facebook (a registered trademark) or Twitter (a registered trademark), the relevant information transmission detecting unit P8 of the information delivery server 4 detects the posted content as the relevant information F8. The posted content is transmitted to the information delivery server 4 through the access point 33 connected to the Internet W.

The priority information generating unit P9 has a function of generating the priority information 13 corresponding to the advertisement information 6 of the advertiser A when the delivery information 8 is delivered from the information delivering unit P5 or when the relevant information F8 is transmitted from the terminal 2. Alternatively, the priority information generating unit P9 has a function of generating the priority information 13 corresponding to the advertisement information 6 of the advertiser A when the delivery information 8 is delivered from the information delivering unit P5 and the relevant information F8 is transmitted from the terminal 2.

As a method of generating the priority information 13 through the priority information generating unit P9, various methods may be used, and for example, the following calculation process may be used. In other words, when a unit price previously decided for each piece of advertisement information is (P), and an advertising effect of each piece of advertisement information is (R), the priority information 13 of the advertisement information can be calculated by the following calculation formula.

Priority information 13 of advertisement information 6=unit price (P)×advertising effect (R).

Here, the unit price P may be a billing amount billed to the advertiser when the advertisement information 6 is provided once through the electronic signage 1. The advertising effect R is an index corresponding to a response (popularity) from the user to the advertisement. In this case, the advertisement information 6 with the priority information 13 of a larger numerical number is transmitted to the electronic signage 1 with a higher priority than the advertisement information 6 with the priority information 13 of a smaller numerical number. When the number of displays of the advertisement information 6 on the electronic signage 1 is N1, the number of deliveries of the delivery information 8 associated with the advertisement information 6 is N8, and the number of transmissions of the relevant information F8 associated with the delivery information 8 is NF8, the advertising effect R may be calculated as following:

Advertising effect (R)=N8,

Advertising effect (R)=N8/N1,

Advertising effect (R)=N8×NF8,

Advertising effect (R)=N8×NF8/N1,

Advertising effect (R)=N8+k×NF8 (where k is a coefficient), or

Advertising effect (R)=(N8+k×NF8)/N1 (where k is a coefficient).

The priority information 13 of each piece of advertisement information 6 is calculated by the calculation process, and each piece of advertisement information 6 is transmitted to the electronic signage 1 based on the priority information 13. Of course, in the fifth embodiment, the relevant information F8 or the usage information F9 may be transmitted from the information delivery server 4 to the electronic signage I or the terminal 22 different from the terminal 2, similarly to the third embodiment.

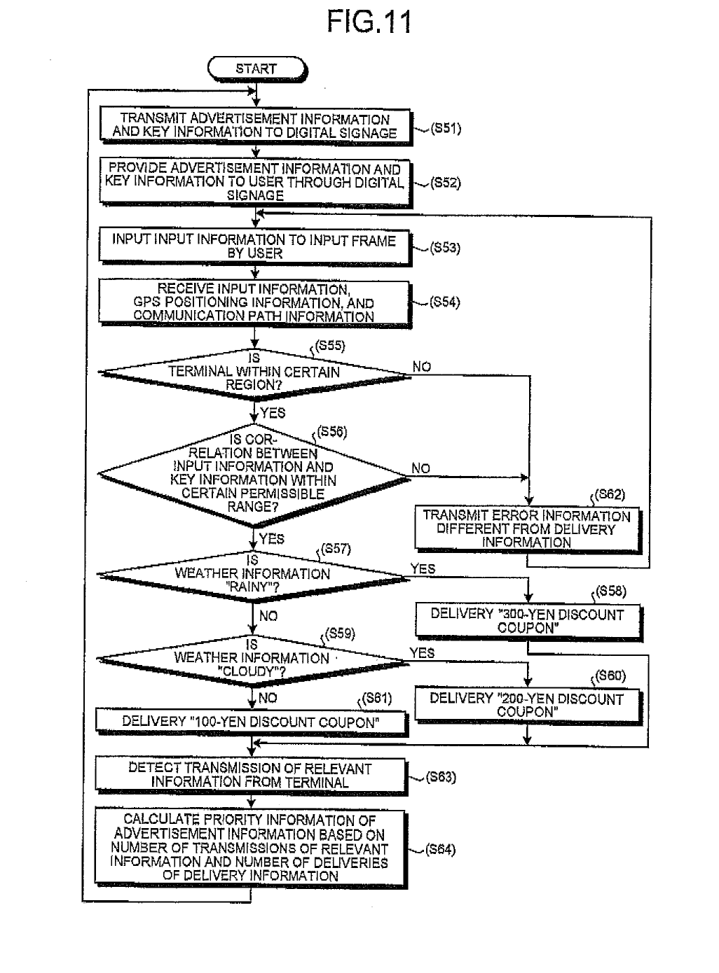

Next, an information delivery process performed by the information delivery server 4 according to the fifth embodiment will be described with reference to a flowchart of FIG. 11.

The advertisement information transmitting unit P1 transmits the advertisement information 6 of the advertiser A and the key information 7 to the electronic signage 1 based on the advertisement information database DB1 (S51). The advertisement information 6 and the key information 7 are transmitted based on the priority information 13, which will be described later. The electronic signage 1 provides the advertisement information 6 and the key information 7 toward the user (S52). The user who has viewed the electronic signage 1 activates the input application in the terminal 2 or accesses a search site and inputs the input information F4 to the input frame (S53). The input information F4 is transmitted to the information delivery server 4 via the AP 33 and the Internet W, and received by the input information receiving unit P2 (S54). At this time, the input information receiving unit P2 receives the GPS positioning information of the terminal 2 and the communication path information F5 together with the input information F4 (554).

The terminal position determining unit P3 determines whether the terminal 2 is within the predetermined region R1 based on the GPS positioning information (S55). The terminal position determining unit P3 determines whether the terminal 2 is within the predetermined region R1 based on the communication path information F5 (555). Here, when the determination based on the GPS information contradicts the determination based on the communication path information F5, the determination based on the communication path information F5 is given priority.

When the terminal 2 is determined to be within the predetermined region R1, the correlation determining unit P4 determines whether the correlation between the input information r4 and the key information 7 is within the predetermined permissible range (S56). Specifically, it is determined whether the passcode input as the input information F4 matches the passcode of the key information 7 by comparing the input passcode with the passcode of the key information 7. Then, when the correlation between the input information F4 and the key information 7 is determined to be within the predetermined permissible range (both pieces of information match each other), the condition information receiving unit P6 receives the weather information 9 from the weather information providing server 12.

The content of the delivery information 8 to be delivered is changed according to the content of the weather information 9, and then the information delivering unit P5 delivers the coupon information serving as the delivery information 8 to the terminal 2. Specifically, when the weather information 9 is “rainy” (S57), “300-yen discount coupon” is delivered to the terminal 2 as the delivery information 8 (S58). When the weather information 9 is “cloudy” (S59), “200-yen discount coupon” is delivered to the terminal 2 as the delivery information 8 (S60). When the weather information 9 is “shiny” (when it is neither rainy nor cloudy) (S59), “100-yen discount coupon” is delivered to the terminal 2 as the delivery information 8 (S61).

The coupon information serving as the delivery information 8 is stored in the terminal 2 of the user, and for example, the user can obtain a benefit (100-yen to 300-yen discount) based on the content of the coupon when doing shopping at the store of the advertiser A.

In the above description, the order of steps 955 and 556 is not consequential. When the terminal position determining unit P3 determines that the position of the terminal 2 is outside the predetermined region R1 in step S55, the information delivering unit P5 transmits error information different from the delivery information 8 such as an error message “you are outside an area” to the terminal 2 (S62). Further, when the correlation determining unit P4 determines that the correlation between the input information F4 and the key information 7 is outside the predetermined permissible range in step S56, the information delivering unit P5 transmits error information different from the delivery information 8 such as an error message “it is an error” to the terminal 2 (562).

The user comes to the store A1 of the advertiser A, and does shopping using the coupon information serving as the delivery information 8 in the terminal 2. The relevant information F8 is transmitted from the terminal 2 to the store server 11. The relevant information F8 or the like is transmitted from the store server 11 to the information delivery server 4 via the Internet W, and the relevant information transmission detecting unit P8 detects the fact that the relevant information F8 has been transmitted from the terminal 2 (S63). The relevant information transmission detecting unit P8 counts the number NF8 of transmissions of the relevant information F8. The information delivering unit P5 counts the number NB of deliveries of the delivery information 8. The priority information 13 of the advertisement information 6 is calculated based on the number NF8 of transmissions of the relevant information F8 and the number N8 of deliveries of the delivery information 8 (S64). Then, the advertisement information 6 of the advertiser A and the key information 7 are transmitted to the electronic signage 1 based on the priority information 13 (S51).

The exemplary embodiments of the present invention have been described above, but the present invention is not limited to the above embodiments, and various changes can be made within the range of the gist thereof. Further, in the above embodiment, the advertisement information database DB1 and the condition information database DB2 are described as separate databases but may be integrated into a single database.

According to an embodiment of the present invention, by ranking delivery information based on instantaneous information from the user, it is possible to increase an information delivery effect.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information delivery device comprising:
an advertisement information database configured to store a plurality of pieces of advertisement information, a plurality of pieces of key information, a plurality of pieces of delivery information, and a plurality of pieces of priority information in association with one another;
an advertisement information transmitting unit configured to transmit one piece of advertisement information of the plurality of pieces of advertisement information to an advertisement providing device based on priority information corresponding to the one piece of advertisement information;
an input information receiving unit configured to receive input information input to a terminal;
a terminal position determining unit configured to determine whether a position of the terminal is within a predetermined region;
a correlation determining unit configured to determine whether a correlation between the input information and the key information corresponding to the one piece of advertisement information is within a predetermined permissible range;
an information delivering unit configured to deliver delivery information corresponding to the one piece of advertisement information to the terminal when the terminal position determining unit determined that the position of the terminal is within the predetermined region and the correlation determining unit determines that the correlation is within the predetermined permissible range;
a relevant information transmission detecting unit configured to detect transmission of relevant information related to the delivery information from the terminal that has received the delivery information delivered by the information delivering unit; and
a priority information generating unit configured to generate the priority information corresponding to the one piece of advertisement information based on at least one of delivery of the delivery information from the information delivering unit and transmission of the relevant information from the terminal.

2. The information delivery device according to claim 1, further comprising:
a condition information database configured to store the delivery information and condition information in association with each other, the condition information being a determination criterion for selecting delivery information to be delivered by the information delivering unit; and
a condition information receiving unit configured to receive an input of the condition information,
wherein the information delivering unit delivers the delivery information to the terminal according to content of the condition information received by the condition information receiving unit.

3. The information delivery device according to claim 1,
wherein the priority information generating unit generates the priority information corresponding to the one advertisement information based on at least one of the number of deliveries of the delivery information from the information delivering unit and the number of transmissions of the relevant information from the terminal.

4. The information delivery device according to claim 1,
wherein the advertisement information transmitting unit provides at least one of delivery number relevant information related to a number of deliveries of the delivery information from the information delivering unit and transmission number relevant information related to a number of transmissions of the relevant information from the terminal to the advertisement providing device together with the one advertisement information.

5. The information delivery device according to claim 1,
wherein when the terminal position determining unit determines that the position of the terminal is outside the predetermined region or when the correlation determining unit determines that the correlation is outside the predetermined permissible range, the information delivering unit transmits error information different from the delivery information to the terminal.

6. The information delivery device according to claim 1,
wherein the terminal position determining unit determines whether the position of the terminal is within the predetermined region using positional information specifying a current position of the terminal.

7. The information delivery device according to claim 1,
wherein the terminal position determining unit determines whether the position of the terminal is within the predetermined region based on at least one of GPS positioning information of the terminal and a communication path until the input information input to the terminal is received by the input information receiving unit.

8. The information delivery device according to claim 7,
wherein when the terminal position determining unit determines whether the position of the terminal is within the predetermined region based on the GPS positioning information and the communication path, and a determination based on the GPS positioning information contradicts a determination based on the communication path, priority is given to the determination based on the communication path.

9. The information delivery device according to claim 1,
wherein the advertisement information transmitting unit transmits the key information to the advertisement providing device together with the advertisement information.

10. An information delivery method causing a computer to execute, using an advertisement information database configured to store a plurality of pieces of advertisement information, a plurality of pieces of key information, a plurality of pieces of delivery information, and a plurality of pieces of priority information in association with one another:
transmitting one advertisement information of the plurality of pieces of advertisement information to an advertisement providing device based on priority information corresponding to the one advertisement information;
receiving input information input to a terminal;
determining whether a position of the terminal is within a predetermined region;
determining whether a correlation between the input information and the key information corresponding to the one advertisement information is within a predetermined permissible range;
delivering delivery information corresponding to the one advertisement information to the terminal when it is determined that the position of the terminal is within the predetermined region and it is determined that the correlation is within the predetermined permissible range;
detecting transmission of relevant information related to the delivery information from the terminal that has received the delivery information delivered in the delivering; and
generating the priority information corresponding to the one advertisement information based on at least one of delivery of the delivery information in the delivering and transmission of the relevant information from the terminal.

11. A computer readable storage medium having stored therein an information delivery program causing a computer to execute a process, using an advertisement information database configured to store a plurality of pieces of advertisement information, a plurality of pieces of key information, a plurality of pieces of delivery information, and a plurality of pieces of priority information in association with one another, the process comprising:
transmitting one advertisement information of the plurality of pieces of advertisement information to an advertisement providing device based on priority information corresponding to the one advertisement information;
receiving input information input to a terminal;
determining whether a position of the terminal is within a predetermined region;
determining whether a correlation between the input information and the key information corresponding to the one advertisement information is within a predetermined permissible range;
delivering delivery information corresponding to the one advertisement information to the terminal when it is determined that the position of the terminal is within the predetermined region and it is determined that the correlation is within the predetermined range;
detecting transmission of relevant information related to the delivery information from the terminal that has received the delivery information delivered in the delivering; and
generating the priority information corresponding to the one advertisement information based on at least one of delivery of the delivery information in the delivering and transmission of the relevant information from the terminal.
